(19) United States
(12) Patent Application Publication
(10) Pub. No.: US 2008/0087058 A1
(43) Pub. Date: Apr. 17, 2008

(54) Unfastening-proof structure for nut sleeves of quick release locks

(75) Inventor: Chin Shu Chang, Changhua City (TW)

Correspondence Address: BRUCE H. TROXELL;SUITE 1404, 5205 LEESBURG PIKE, FALLS CHURCH, VA, 22041, US

(73) Assignee: VULCAN SPORTS CO., LTD.

(21) Appl. No.: 11/545,781

(22) Filed: Oct. 11, 2006

(51) Int. Cl. E05B 71/00

(52) U.S. Cl. 70/233; 411/432

(57) ABSTRACT

A unfastening-proof structure for nut sleeves of quick release locks and particularly to a structure capable of preventing a nut sleeve from being unfastened to achieve theft-thwarting function includes a quick release mechanism on a quick release lock which has a lock assembly on one end. The quick release mechanism includes a rod which has a threaded portion on a distal end to be coupled with a nut sleeve. The nut sleeve includes a rotary tray, an elastic element, an inner sleeve, a barrel and a plug. The inner sleeve is disengaged with the barrel after the quick release lock is in a locking condition so that when an external force is applied to turn the nut sleeve, an idle rotation is formed. Therefore the nut sleeve cannot be unfastened to achieve the theft-thwarting effect.

### BACKGROUND OF THE INVENTION

1. Field of the Invention

The present invention relates to a unfastening-proof structure for nut sleeves of quick release locks and particularly to a structure capable of preventing a nut sleeve from being unfastened to achieve theft-thwarting effect.

2. Description of the Prior Art

Conventional quick release mechanisms can be disassembled quickly to replace elements, thus are widely used on bicycles. However they generally do not offer theft-thwarting function. U.S. Pat. No. 5,479,836 discloses a quick release having an anti-theft device as shown in FIG. 9 in that case. Its structure is substantially like a conventional quick release lock shown in FIG. 1 of this application. The quick release lock shown in FIG. 1 includes a quick release mechanism 9 on one end of a rod 90 which has a threaded portion 91 on other end to be coupled with a nut 92. When in use the rod 90 runs through a sleeve B to enable users to turn through a handle 93 so that an eccentric bar 931 drives the nut 92 in the direction of the quick release mechanism 9 to allow the sleeve B to be fastened or unfastened quickly. The quick release mechanism 9 has a lock assembly 94 to control rotation of the handle 93 thereby to provide theft-thwarting function.

While the conventional quick release mechanism 9 mentioned above has the lock assembly 94 to guard against pilferage, the nut 92 on the other end of the rod 90 can be unfastened easily through a tool. Thus the theft-thwarting function is not effective.

### SUMMARY OF THE INVENTION

In view of the aforesaid problem, the present invention aims to provide a unfastening-proof structure for nut sleeves of quick release locks. This invention includes a quick release mechanism on a quick release lock which has a lock assembly on one end. The quick release mechanism has a rod which has a threaded portion on a distal end to be coupled with a nut sleeve. The nut sleeve includes a rotary tray, an elastic element, an inner sleeve, a barrel and a plug. The inner sleeve is engaged with the barrel when the quick release lock is in a locking condition so that an idle rotating condition is formed when the nut sleeve is turned by an external force. Thereby the nut sleeve cannot be unfastened and theft-thwarting function can be achieved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional quick release device.

FIG. 2 is a perspective view of the invention.

FIG. 3 is an exploded view of the invention.

FIG. 4 is a sectional view of the invention in an operating condition.

FIG. 5 is a cross section taken on line I-I in FIG. 4.

FIG. 6 is a sectional view of the invention in another operating condition.

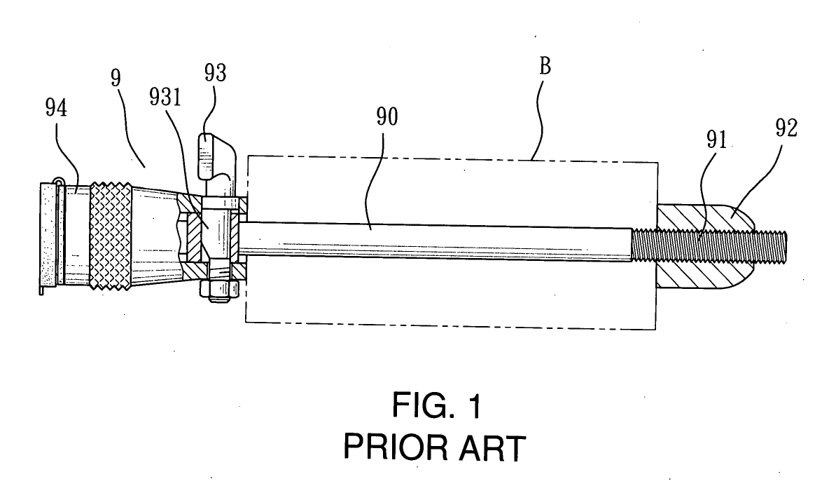

### DESCRIPTION OF THE PREFERRED EMBODIMENT

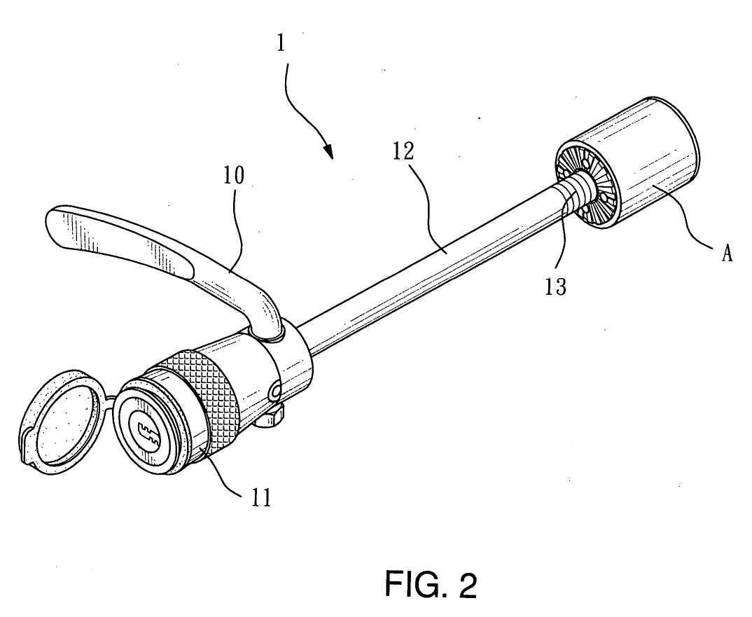

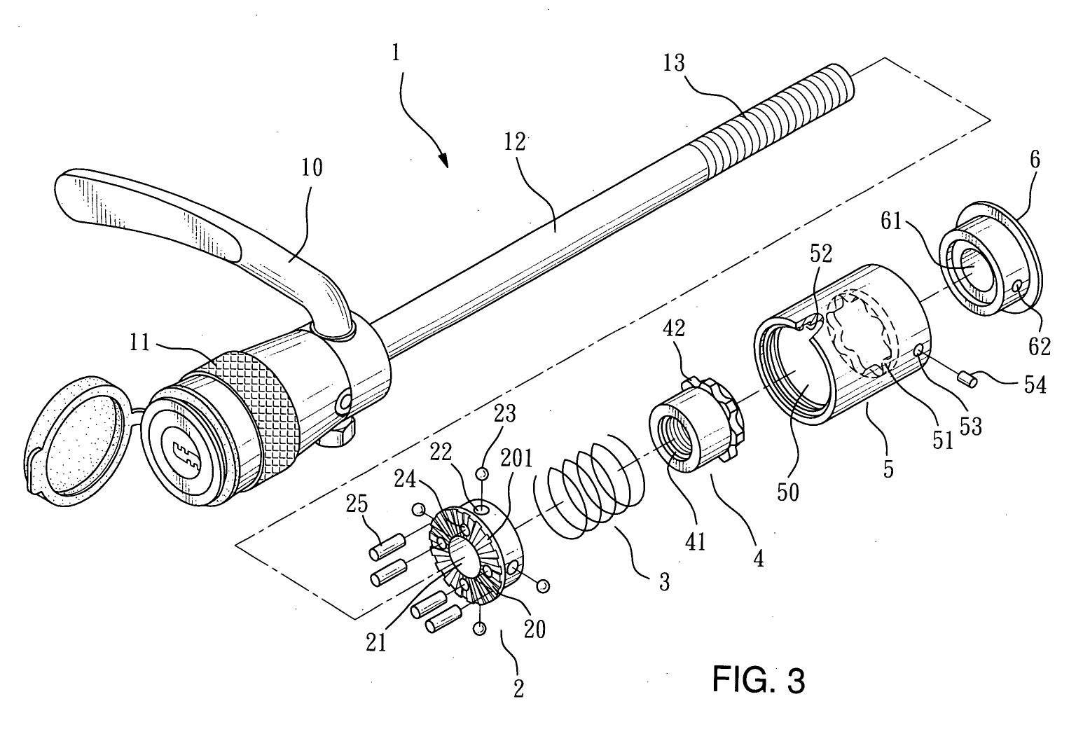

Referring to FIGS. 2 and 3, the unfastening-proof structure for nut sleeves of quick release locks according to the invention includes a quick release mechanism 10 on a quick release lock 1 which has a lock assembly 11 on one end (the quick release lock is constructed like the conventional one, thus details are omitted hereunder). The quick release mechanism 10 has a rod 12 which has a threaded portion 13 on a distal end to be coupled with a nut sleeve A. The nut sleeve A includes a rotary tray 2, an elastic element 3, an inner sleeve 4, a barrel 5 and a plug 6.

The rotary tray 2 has an opening 21 in the center, at least one bead cavity 22 on the periphery to hold corresponding number of beads 23, and a first surface 20 which has one or more bolt cavity 24 formed thereon corresponding to the bead cavity 22 and communicating with the bead cavity 22 in a perpendicular manner to be inserted by one or more bolt 25 to adjust the depth of the beads 23 held therein. The first surface 20 further has a plurality of troughs 201 to increase the friction index of the contact surface when assembled.

The elastic element 3 is a spring.

The inner sleeve 4 has an internal screw hole 41 to be coupled with the threaded portion 13 of the rod 12 and a first teeth rack 42 on the periphery.

The barrel 5 has a through hole 50 and a second teeth rack 51 on an inner periphery thereof, and a groove 52 on an inner rim close to the edge of the through hole 50 to retain the beads 23 on the rotary tray 2. The barrel 5 further has at least one bolt aperture 53 on the periphery of a rear portion to be inserted by a bolt 54.

The plug 6 is coupled with one side of the through hole 50 and has an aperture 61 in the center, and at least one bolt cavity 62 on the periphery to be inserted by the bolt 54.

By means of the elements set forth above, the inner sleeve 4, elastic element 3 and rotary tray 2 are placed in this order into the through hole 50 of the barrel 5, with the beads 23 held in the groove 52, and the bolt 25 inserted into the bolt cavity 24 so that the elements mentioned above are held in the through hole 50, and the inner sleeve 4 can be moved forwards and backwards in the through hole 50. The plug 6 is latched in the barrel 5 after the bolt 54 has been inserted into the bolt aperture 53 and bolt cavity 62. Thus the rod 12 can be assembled with a coupling element C after the nut sleeve A is fastened to the threaded portion 13.

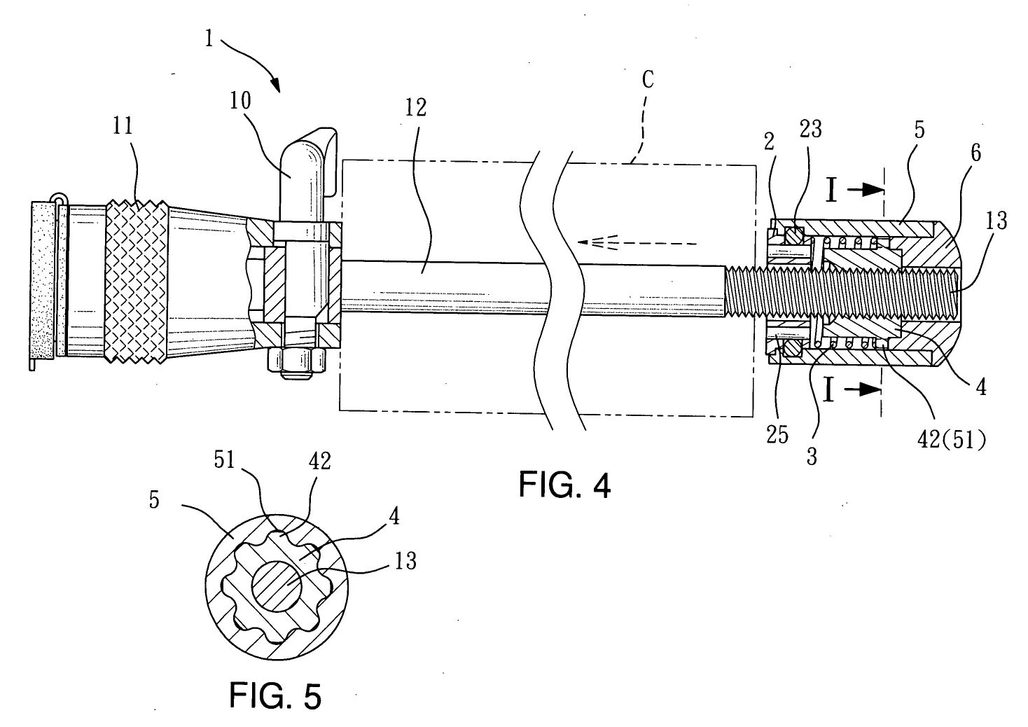

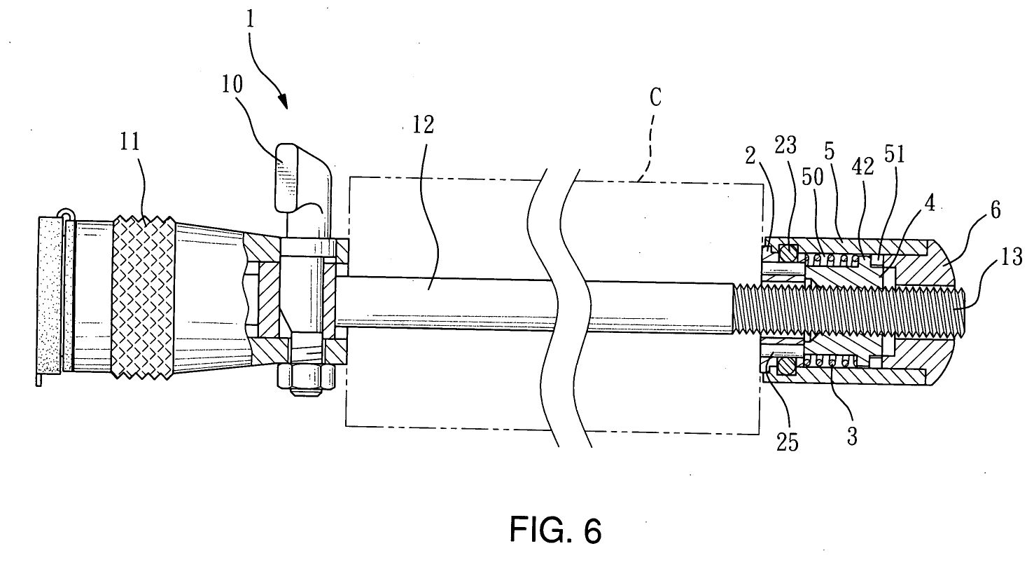

Referring to FIGS. 4 and 5, when the quick release mechanism 10 is in a release condition, the elastic element 3 pushes the inner sleeve 4 in normal conditions and the first teeth rack 42 and the second teeth rack 51 are engaged so that turning the barrel 5 can drive the inner sleeve 4 and the threaded portion 13 of the rod 12 is rotated and moved forwards or backwards. On the other hand, when the quick release mechanism 10 is in a compressed condition (referring to FIG. 6), the rod 12 is thrust towards the quick release mechanism 10, the inner sleeve 4 coupled on the threaded portion 13 compresses the elastic element 3, and the first teeth rack 42 is disengaged with the second teeth rack 51. Therefore when the quick release lock 1 is locked and an external force is applied to turn the barrel 5, it rotates idly on the groove 52 and the inner sleeve 4 is not driven. Thus the nut sleeve A cannot be unfastened, and theft-thwarting function can be accomplished.

In short, the quick release mechanism of the invention can provide the function as desired, and also offer theft-thwarting effect. It provides a significant improvement over the conventional techniques.

I claim:

1. A unfastening-proof structure for nut sleeves of quick release locks comprising a quick release mechanism on a quick release lock which has a lock assembly on one end, the quick release mechanism having a rod which has a threaded portion on a distal end to be coupled with a nut sleeve, the nut sleeve including:
a rotary tray which has an opening in the center and at least one bead cavity on the periphery to hold beads corresponding to the bead cavity;
an elastic element;
an inner sleeve which has an internal screw hole and a first teeth rack on one end;
a barrel which has a through hole and a second teeth rack on a rear portion of the through hole; and
a plug which is engaged with one side of the through hole of the barrel and has an aperture in the center.

2. The unfastening-proof structure of claim 1, wherein the rotary tray has a first surface which has at least one bolt cavity formed thereon to be inserted by at least one bolt to adjust the depth of the beads held thereon.

3. The unfastening-proof structure of claim 1, wherein the rotary tray has a first surface which has a plurality of troughs formed thereon.

4. The unfastening-proof structure of claim 1, wherein the barrel has a groove on an inner rim close to an edge of the through hole to hold the beads.
